(19) United States
(12) Patent Application Publication
(10) Pub. No.: US 2010/0158376 A1
(43) Pub. Date: Jun. 24, 2010

(54) SYSTEMS AND METHODS FOR LABELING AND CHARACTERIZATION OF CONNECTED REGIONS IN A BINARY MASK

(76) Inventors: Peter S. Klosterman, Piedmont, CA (US); Daniel X. Pape, Portland, OR (US)

Correspondence Address: FlashFoto, Inc.;ATTN: Osama Hussain Esq., Suite 1020, 436 14th St., Oakland, CA, 94612, US

(21) Appl. No.: 12/581,324

(22) Filed: Oct. 19, 2009

Related U.S. Application Data
(60) Provisional application No. 61/196,530, filed on Oct. 17, 2008.

(51) Int. Cl. G06K 9/34

(52) U.S. Cl. 382/180

(57) ABSTRACT

Systems and methods, which is based on preprocessing of a binary image into runs of adjacent white pixels, rapidly labels the connected components of the binary image, calculates the ellipse parameters of the connected regions, identifies connected regions which are distant from known foreground regions, and identifies those pixels whose Euclidean distance from the input binary mask is between two thresholds. The execution time of the first phase, the scanning of the input image and identification of adjacent runs of white pixels, scales as the number of pixels, is CPU memory cache sensitive, and very simple. The execution time of the subsequent processing stages for the various components of the systems and methods scale as the number of runs of pixels, so in most cases, for large input images, is considerably faster than conventional processes, which scale as the number of pixels.

### CROSS-REFERENCE TO RELATED APPLICATION

This application claims priority to U.S. Patent Application No. 61/196,530, entitled “Systems and methods for labeling and characterization of connected regions in a binary mask,” filed Oct. 17, 2008, which is hereby incorporated by reference herein in its entirety.

### FIELD

Systems for rapid labeling and characterization of connected regions in a binary mask, and methods for making and using same are provided.

### BACKGROUND

Labeling connected components in a digital image is a classic problem in image processing and pattern recognition. (See Rosenfeld and Pfaltz, 1966, “Sequential Operations in Digital Picture Processing”, Journal of the Association for Computing Machinery 13, 471-494; Shima et al., 1990, “A High-speed algorithm for propagation-type labeling based on block sorting of runs in binary images”, 10^{th} International Conference on Pattern Recognition, Proceedings 1, 655-658; Fiorio and Gustedt, 1996, “Two linear time Union-Find strategies for image processing”, Theoretical Computer Science 154, 165-181; Suzuki et al., 2003, “Linear-time connected-component labeling based on sequential local operations”, Computer Vision and Image Understanding 89, 1-23; Chang et al., “A linear-time component-labeling algorithm using contour tracing technique”, Computer Vision and Image Understanding 93, 206-220; Wu et al., 2005, “Optimizing Connected Component Labeling Algorithms”, Medical Imaging Processing, Proceedings of the SPIE 5747, 1965-1976; each of which is hereby incorporated by reference in its entirety.)

This is important for the separation of objects and is useful for the extraction of character and picture regions in document images, the recognition of symbols in drawings, and the extraction of components in computer vision.

The processing time for labeling increases sharply when the size of the image becomes larger, so many researchers have presented a wide range of methods for high-speed connected component labeling.

The most commonly used algorithms fall into the following classes: (A) processes which perform repeat passes through an image to propagate label equivalences, (B) two-pass processes, with provisional labeling in the first pass followed by a second pass which resolves the label equivalences, and (C) processes using hierarchical trees to speed up the resolution of label equivalences. Shima et al., 1990, “A High-speed algorithm for propagation-type labeling based on block sorting of runs in binary images”, 10^{th} International Conference on Pattern Recognition, Proceedings 1, 655-658 describe a process for propagation-type labeling based on block sorting of runs in binary images.

The disclosed systems and methods also provide binary image analysis functionality that is conventionally obtained using the distance transform which contains, for each pixel, the distance between that pixel and the pixel of value 1 closest to it. The distance transform was also first introduced by Rosenfeld and Pfaltz; although the Euclidean metric is the most informative, other metrics, in particular the chamfer metric, give nearly the same result with much faster processing (See Paglieroni, 1992, “Distance Transforms: Properties and Machine Vision Applications”, CVGIP: Graphical Models and Image Processing 54, 56-74; which is hereby incorporated by reference in its entirety. Each row of the bit map can be processed independently, giving the horizontal distance transform. Algorithms based on the Voronoi diagram produce the distance transform in linear time in the number of pixels (See Breu et al., 1995, “Linear Time Euclidean Distance Transform Algorithms”, IEEE Transactions on Pattern Analysis and Machine Intelligence 17, pp. 529-533; which is hereby incorporated by reference herein in its entirety).

As with connected component labeling, all of the algorithms for the distance transform require substantial processing time on large images.

Thus, given the above background, what is needed in the art are improved systems for rapid labeling and characterization of connected regions in a binary mask, and methods for making and using same

### BRIEF DESCRIPTION OF DRAWINGS

The accompanying drawings, which are included as part of the present specification, illustrate the presently preferred embodiments and together with the general description and the detailed description of the embodiments given below serve to explain and teach the principles of the disclosed embodiments.

FIG. 1 is an illustration of an exemplary computer architecture for use with the present system, according to one embodiment.

### DETAILED DESCRIPTION

In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of sub-processes leading to a desired result. These sub-processes are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be born in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The disclosed embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a tangible computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct more specialized apparatus to perform the required method sub-processes. The required structure for a variety of these systems will appear from the description below. In addition, the disclosed embodiments are not described with reference to any particular programming language. It will be appreciated that a variety of programming languages may be used to implement the teachings of the disclosed embodiments.

In some embodiments an image is a bitmapped or pixmapped image. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2n colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

Segmentation refers to the process of partitioning a digital image into multiple regions (sets of pixels). The goal of segmentation is to simplify and/or change the representation of an image into something that is more meaningful and easier to analyze. Image segmentation is typically used to locate objects and boundaries (lines, curves, etc.) in images.

The result of image segmentation is a set of regions that collectively cover the entire image, or a set of contours extracted from the image. Each of the pixels in a region share a similar characteristic or computed property, such as color, intensity, or texture. Adjacent regions are significantly different with respect to the same characteristic(s).

Several general-purpose algorithms and techniques have been developed for image segmentation. Exemplary segmentation techniques are disclosed in The Image Processing Handbook, Fourth Edition, 2002, CRC Press LLC, Boca Raton, Fla., Chapter 6, which is hereby incorporated by reference herein for such purpose. Since there is no general solution to the image segmentation problem, these techniques often have to be combined with domain knowledge in order to effectively solve an image segmentation problem for a problem domain.

Throughout the present description of the disclosed embodiments described herein, all steps or tasks will be described using multiple embodiments. However, it will be apparent to one skilled in the art, that the order of the steps described could change in certain areas, and that the embodiments are used for illustrative purposes and for the purpose of providing understanding of the inventive properties of the disclosed embodiments.

All of the parts disclosed in the embodiments of the systems and methods are based on first combining adjacent white (non-zero) pixels in a scan row into runs. Runs may be created by utilizing run-length encoding. Run-length encoding is a form of data compression in which runs of data (that is, sequences in which the same data value occurs in many consecutive data elements) are stored as a single data value and count, rather than as the original run.

The image is processed row by row, or in the order the pixels are stored in memory, giving a performance improvement by decreasing the number of times the CPU memory cache is read from main memory. The result is a highly compact representation of the binary image, with each run represented only by the row, the column number of the first white pixel, and the column number of the first black pixel following the run. One example of a binary image is an image mask. An image mask may be created by any conventional type of image mask creation operation, such as in the manners set forth in the co-pending United States patent application, entitled “Systems And Methods For Unsupervised Local Boundary or Region Refinement of Figure Masks Using Over and Under Segmentation of Regions,” application Ser. No. 12/333,293, filed on Dec. 11, 2008; co-pending United States provisional patent application, entitled “Systems And Methods for Segmentation by Removal of Monochromatic Background With Limited Intensity Variations,” Application No. 61/168,619, filed on Apr. 13, 2009 and co-pending Patent Cooperation Treaty application, entitled “Systems and Methods for Rule-Based Segmentation for Objects With Full or Partial Frontal View in Color Images,” Serial No. PCT/US2008/013674, filed on Dec. 12, 2008, which are all assigned to the assignee of the present application and the respective disclosures of which are hereby incorporated herein by reference in their entirety.

During the scan process, references to the runs in a given row are sorted according to the run's starting column number, and stored in balanced trees; this sorting speeds up combining of runs into connected regions later, since connected runs in adjacent rows have similar starting columns. The use of balanced trees to store the run co-ordinates assists or speeds up the search for nearby runs and run deletion in the merging phase. References to the sorted runs in each row may be stored in an array for easy access.

When connected runs are merged into connected regions, the image is again processed row by row, or in the order the pixels are stored in memory (as mentioned above). Any runs in a given row that are not already assigned to a region are identified and processed. For example, the first such run in the row is pushed onto a stack and optionally flagged, or otherwise marked, as being pushed. In one embodiment, the stack is then processed until empty. As a run is popped from the stack, adjacent rows of the image are searched for runs not already assigned to a connected region. Those that are found to be adjacent are also pushed onto the stack; the run that has just been popped from the stack is added to the connected region being generated.

The execution time of the second phase is proportional to the number of runs, which in most cases, where a large number of adjacent pixels are all white or all black, is much smaller than the total number of pixels. Thus, this processing is sub-linear in execution time.

An additional embodiment includes the calculation of the axes lengths, orientation, and eccentricity of the ellipse that has the same normalized second moments as the region. This calculation may be added to the above mentioned merging stage, following the algorithm described in Haralick and Shapiro, 1992, Computer and Robot Vision Volume I, Addison-Wesley, Appendix A, which is hereby incorporated by reference in its entirety. This step may be useful in determining which connected regions are likely to be part of the image background, e.g., long, thin, horizontal regions, which are seldom found in people.

In another embodiment, connected regions for which all white pixels are greater than a threshold from given regions of the input image are identified to determine which connected regions are likely to be part of the image background, since they are far away from regions already identified as part of the image foreground. One example process may first identify the connected regions in the binary image, identify those regions which overlap the known rectangles (for example, resized face rectangles), calculate the Euclidean distance transform of the binary image made of the regions in the image foreground and then find the minimum distance between each connected region and the foreground regions. Examples of known rectangles include, but are not limited to, detected human faces or “face rectangles” as defined in co-pending Patent Cooperation Treaty patent application, entitled “Systems and Methods for Rule-Based Segmentation for Objects With Full or Partial Frontal View In Color Images,” Application No. PCT/US2008/013674, filed on Dec. 12, 2008, which is assigned to the assignee of the present application and the respective disclosure of which is hereby incorporated herein by reference in its entirety.

In another alternative embodiment, the connected regions of the input mask are identified, thus providing time saving references to the run coordinates in balanced trees, that is, one for each row. Those connected regions that intersect with the foreground rectangles may then be identified. The processing time for this step may also be proportional to the number of runs and not the number of pixels since only the first and last pixel in a run needs to be checked. Having references to runs stored sorted in balanced trees may speed up the search for overlap, since the runs closest to a given rectangle are quickly identified. Once the connected regions that intersect the foreground rectangles are identified, a final scan of the remaining connected regions may quickly identify those connected regions above the threshold distance from any connected region intersecting the known foreground rectangles. This step may be also processed in time proportional to the number of runs, sub-linear in the number of pixels, since only the distance from beginning and ending pixels of a run may need to be calculated.

In an additional alternative embodiment, the pixels whose Euclidean distance from the input binary mask is between a lower and an upper threshold are identified in order to assist in the refinement of the segmented mask. One of the inputs required by Grady et al.'s random walk algorithm (See Grady et al., 2005, “Random Walks for Interactive Alpha-Matting”, Visualization, Imaging, And Image Processing: Fifth IASTED International Conference Proceedings, which is hereby incorporated by reference in its entirety) for figure—ground segmentation (alpha-matting) is a trimap of the pixels, indicating which foreground, background, and unknown regions. In refining the border of a segmentation mask, it is convenient to define the unknown region using the distance transform of the existing mask, selecting as unknown pixels whose Euclidean distance is greater than a lower threshold and less than an upper threshold from either the foreground or background region.

One embodiment of the disclosed systems and methods first identifies candidates between threshold pixels for the white runs by processing the input binary image row by row and eliminating the identified pixels that are closer than the lower threshold to input image pixels in the other rows.

The basic question this step poses is as follows: for a pair of pixels, one in the input mask and the other a candidate for the unknown mask, is the Euclidean distance between them greater than the lower threshold and less than the upper threshold? Since the answer is dependent only on the delta (or “change in”) in row and column numbers of the two pixels, one may first construct a prototype disk, for example a filled-in circle, (saving the beginning and ending column offsets for each row delta) describing which pixels meet these conditions. Since the values of these indices is determined only by the two thresholds, they can be calculated once and reused for a large number of input binary images.

Using the Euclidean norm, one may reduce the number of calculations of the row difference squared plus the column distance squared by starting with row difference zero, for which the offsets for inclusion in the output mask are, for the case of integer thresholds, just the upper threshold minus one and the lower threshold. Then, one may increase the row difference and process inward, decreasing the column difference until the point with those relative co-ordinates is inside the disk. For many cases, this requires calculating the square of the column difference.

To find the between thresholds pixels for a given input binary image, using the already calculated distance thresholds described above, one may first scan the input image, row by row, for white runs, which for each row references to the column indices are stored in a balanced tree as described above.

Next, for each row in the input image which contains any white (non-zero) pixels, one may find all of the between threshold pixels that would be generated if this were the only row with any white pixels, ignoring possible conflicts (below lower threshold distances) with pixels in other rows. In general, each input row will generate multiple rows of between threshold pixels; for each input run, and each possible output row, one may generate candidates between threshold runs to the left and the right of the input run, extending or deleting previously generated output between threshold runs if there is overlap or a conflict.

Since each input row generally generates several rows of output, adjacent input image rows are frequently similar, and the process of checking output rows for conflict with other input rows is complex, one may keep track of output runs which have already been tested for conflicts. Newly generated output runs which overlap runs that have been tested are deleted; if part of a newly generated output run has already been tested, the already tested pixels are deleted from the new runs.

The remaining newly generated output runs are then copied into the tested runs, merging adjacent runs. These new output runs are then checked for any pixels which are closer than the lower threshold to an input pixel, deleting those pixels, in many cases the entire newly generated output run. The remaining newly generated output runs, for the input row being processed, are then added to the overall output runs, merging adjacent runs.

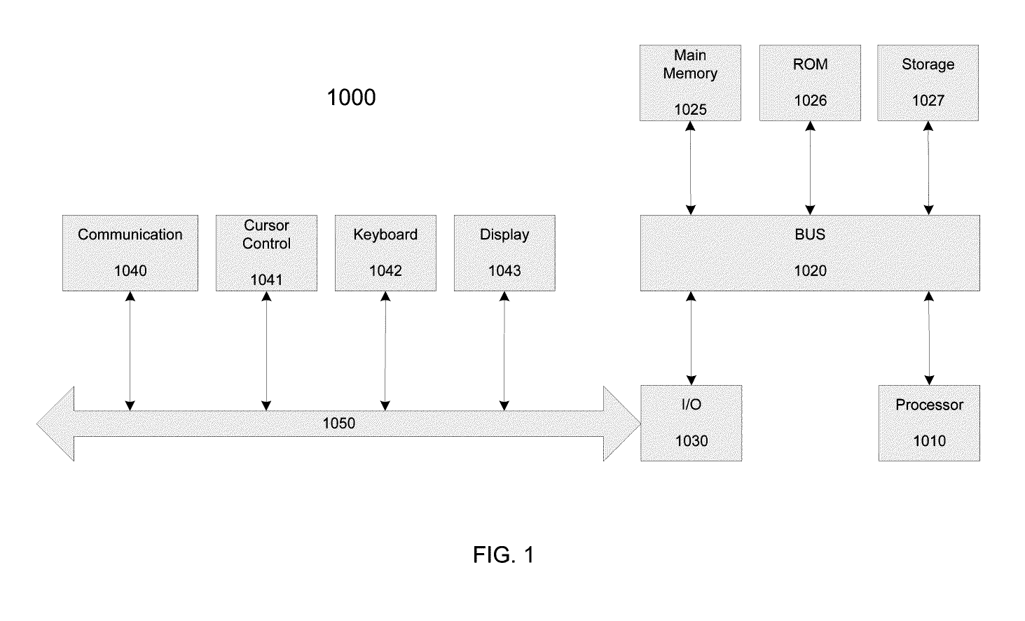

FIG. 1 is an illustration of an exemplary computer architecture for use with the present system, according to one embodiment. Computer architecture 1000 is used to implement the computer systems or image processing systems described in various embodiments. One aspect of the present disclosure provides a computer system, such as exemplary computer architecture 1000, for implementing any of the methods disclosed herein. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010.

A data storage device 1027 such as a magnetic disk or optical disk and its corresponding drive is coupled to computer system 1000 for storing information and instructions. Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

The disclosure is susceptible to various modifications and alternative forms, and specific examples thereof have been shown by way of example in the drawings and are herein described in detail. It should be understood, however, that the disclosure is not to be limited to the particular forms or methods disclosed, but to the contrary, the disclosure is to cover all modifications, equivalents, and alternatives. In particular, it is contemplated that functional implementation of the disclosed embodiments described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of the disclosed embodiments not be limited by this detailed description, but rather by the claims following.

What is claimed:

1. A method of characterizing respective pixels in a digital image as foreground or background pixels, the method comprising:
(A) processing a binary mask corresponding to the digital image, wherein the binary mask comprises a plurality of rows, in order to identify a plurality of runs, wherein each row in the plurality of rows comprises a plurality of pixels and wherein each pixel in the plurality of pixels has a first value or a second value, wherein
a respective pixel in the plurality of pixels having the first value indicates that the respective pixel is identified as being part of the foreground of a digital image corresponding to the binary mask,
a pixel in the plurality of pixels having the second value indicates that the respective pixel is identified as being part of the background of the digital image, and wherein the processing comprises processing the plurality of rows in a row by row manner, and wherein the plurality of pixels in a respective row in the plurality of rows is processed by said processing in an order in which pixels in the plurality of pixels in the respective are stored in a memory, thereby identifying a plurality of runs of white pixels in the mask, wherein
a first run of white pixels in the plurality of runs of white pixels is identified by a respective row in the plurality of rows, a column number of a first white pixel in the plurality of pixels in the respective row, and a column number of a first black pixel following the first run of white pixels; and
(B) using the plurality of runs to refine the mask thereby characterizing respective pixels in a digital image as foreground or background pixels.

2. The method of claim 1, wherein the plurality of runs are stored in a balanced tree.

3. The method of claim 1, wherein the using (B) comprises, for each respective set of runs in the plurality of runs that connect to each other, forming a region for the respective set of runs thereby forming a plurality of regions.

4. The method of claim 3, the method further comprising:
(C) scanning the mask, on a row by row basis, for each respective run in the plurality of runs that has not been assigned to a region in the plurality of regions by the using (B), wherein, when a respective run that has not been assigned to a region in the plurality of regions is identified, the scanning (C) further comprises pushing the respective run onto a stack.

5. The method of claim 4, the method further comprising:
(D) popping a respective run from the stack;
(E) identifying runs, from among the runs in the plurality of runs that are not assigned to a region in the plurality of regions, in rows in the mask that are adjacent to the row that contains the respective run in the mask; and
(F) pushing the respective run and the runs identified by the identifying (E) onto the stack.

6. The method of claim 3, the method further comprising
characterizing a respective region in the plurality of regions as background when each pixel in the respective region is more than a threshold distance from a portion of the image that has been independently identified as image foreground; and
characterizing a respective region in the plurality of regions as foreground when a pixel in the respective region is less than a threshold distance from a portion of the image that has been independently identified as image foreground.

7. The method of claim 6, wherein the portion of the image that has been independently identified as image foreground is a face rectangle.

8. The method of claim 6, wherein the threshold distance is a predetermined Euclidean distance.

9. The method of claim 3, the method further comprising:
determining which regions in the plurality of regions connect to each other thereby identifying a plurality of interconnected regions; and
identifying an interconnected region in the plurality of interconnected regions that overlaps with a portion of the image that has been independently identified as foreground.

10. The method of claim 9, wherein the portion of the image that has been independently identified as image foreground is a face rectangle.

11. The method of claim 9, wherein a first region and a second region in the plurality of regions connect to each other when there is at least one pixel in the mask that is in both the first region and the second region.

12. The method of claim 9, wherein an interconnected region in the plurality of interconnected regions overlaps with a portion of the image that has been independently identified as foreground when there is at least one pixel in the mask that is in both the interconnected region and the portion of the image that has been independently identified as foreground.

11. The method of claim 9, the method further comprising characterizing a respective region in the plurality of regions as background when each pixel in the respective region is more than a threshold distance from any pixel of any interconnected region that overlaps a portion of the image that has been independently identified as foreground.

12. The method of claim 3, the method further comprising calculating an axis length, orientation, and eccentricity of an ellipse that has the same normalized second moment as a region in the plurality of regions.

13. The method of claim 1, the method further comprising outputting the plurality of runs or the refined mask.

14. The method of claim 3, the method further comprising outputting the plurality of regions.

15. A computer program product for use in conjunction with a computer system, the computer program product comprising a computer readable storage medium and a computer program mechanism embedded therein, the computer program mechanism for characterizing respective pixels in a digital image as foreground or background pixels, the computer program mechanism comprising computer executable instructions for:
(A) processing a binary mask corresponding to the digital image, wherein the binary mask comprises a plurality of rows, in order to identify a plurality of runs, wherein each row in the plurality of rows comprises a plurality of pixels and wherein each pixel in the plurality of pixels has a first value or a second value, wherein
a respective pixel in the plurality of pixels having the first value indicates that the respective pixel is identified as being part of the foreground of a digital image corresponding to the binary mask,
a pixel in the plurality of pixels having the second value indicates that the respective pixel is identified as being part of the background of the digital image, and wherein the processing comprises processing the plurality of rows in a row by row manner, and wherein the plurality of pixels in a respective row in the plurality of rows is processed by said processing in an order in which pixels in the plurality of pixels in the respective are stored in a memory, thereby identifying a plurality of runs of white pixels in the mask, wherein
a first run of white pixels in the plurality of runs of white pixels is identified by a respective row in the plurality of rows, a column number of a first white pixel in the plurality of pixels in the respective row, and a column number of a first black pixel following the first run of white pixels; and
(B) using the plurality of runs to refine the mask thereby characterizing respective pixels in a digital image as foreground or background pixels.

16. A computer, comprising:
a memory;
a processor;
and instructions stored in the memory and executable by the processor, the instructions comprising instruction for:
(A) processing a binary mask corresponding to the digital image, wherein the binary mask comprises a plurality of rows, in order to identify a plurality of runs, wherein each row in the plurality of rows comprises a plurality of pixels and wherein each pixel in the plurality of pixels has a first value or a second value, wherein
a respective pixel in the plurality of pixels having the first value indicates that the respective pixel is identified as being part of the foreground of a digital image corresponding to the binary mask,
a pixel in the plurality of pixels having the second value indicates that the respective pixel is identified as being part of the background of the digital image, and wherein the processing comprises processing the plurality of rows in a row by row manner, and wherein the plurality of pixels in a respective row in the plurality of rows is processed by said processing in an order in which pixels in the plurality of pixels in the respective are stored in a memory, thereby identifying a plurality of runs of white pixels in the mask, wherein
a first run of white pixels in the plurality of runs of white pixels is identified by a respective row in the plurality of rows, a column number of a first white pixel in the plurality of pixels in the respective row, and a column number of a first black pixel following the first run of white pixels; and
(B) using the plurality of runs to refine the mask thereby characterizing respective pixels in a digital image as foreground or background pixels.
